(19) United States
(12) Patent Application Publication
(10) Pub. No.: US 2008/0112270 A1
(43) Pub. Date: May 15, 2008

(54) WATER-PROOF WATCH CASE WITH GPS AND A METHOD FOR MANUFACTURING THE SAME

(75) Inventors: Ming-Lung Yeh, Chung Ho City (TW); Ming-Jian Su, Chung Ho City (TW)

Correspondence Address: GLOBALSAT TECHNOLOGY CORPORATION, P.O. BOX 108-00403, TAIPEI 106, omitted

(73) Assignee: GLOBALSAT TECHNOLOGY CORPORATION, Chung Ho City (TW)

(21) Appl. No.: 11/559,902

(22) Filed: Nov. 15, 2006

(51) Int. Cl. G04B 37/08; G04D 3/00; G04B 47/06

(52) U.S. Cl. 368/14; 368/291; 29/896.3

(57) ABSTRACT

A water-proof watch case and a method for manufacturing the same are disclosed. First, a design of a case and a bottom lid is decided, and a mold according to the design is fabricated accordingly. Next, a hard plastic material is injected into the mold to form the case and the bottom lid. Next, a soft plastic material is injected at an outer rim of the case to form at least one button, and a soft plastic material is injected at a conjunction between the case and the bottom lid to form a water-proof gasket. Finally, the hard and soft plastic materials are heated to adhere the button and the water-proof gasket to the outer rim of the case and the conjunction between the bottom lid and the case respectively.

### BACKGROUND OF THE INVENTION

1. Field of the Invention

The present invention is related to a water-proof watch case with global positioning system (GPS) and a method for manufacturing the same. More particularly, to such a watch case comprised of two different plastic materials with different properties to achieve the water-proof effect and also increase the production throughput of the same.

2. Description of Related Art

Nowadays, most people wear watches as an essential part of our life. Watches are available in a variety of designs. Generally, the shapes of the watch are usually round, oval, square and rectangle.

Furthermore, the materials of the watch case generally include plastic, aluminum alloy, copper alloy and stainless steel, and may be manufactured by using conventional methods such as plastic injection molding, zinc-aluminum alloy casting, plate flushing and pressing and so on. However, the flushing and pressing method can not produce the complex structure and meet special requirements such as square blind, complicated pattern or indented/protruded letters on the case, and so on. It is interesting to note that it is possible to manufacture more varieties of watch case by plastic injection molding process and also suitable for mass production. Thus, the manufacturing cost can be reduced.

Generally, the plastic watch comprises a case, movement components and a bottom lid. The movement components are embedded into the conjunction between the case and the bottom lid. For providing better water-proof effect, a set of embedded elements and a water-proof gasket are used to secure and seal the conjunction between the bottom lid and the case to prevent the water entering into the case from the conjunction. Furthermore, the case has a least one space formed at an outer rim thereof, and at least one button is positioned on the space. And a lens is embedded on the case.

In the latest fashion, watches include GPS (global position system) inside the case. The watches also include structures, for example a set of embedded elements (a groove and a rib) for jointing the bottom lid to the case and a water-proof gasket disposed between the bottom lid and the case to tightly seal the bottom lid and the case for providing better water-proof effect.

However, it is difficult to achieve the water-proof effect. The case and the bottom lid are made of hard plastic materials, and a set of embedded elements (a groove of the bottom lid and a rib of the case) is formed between the bottom lid and the case. Next, an adhesive may be manually injected into the groove of the bottom lid, and then the water-proof gasket made of soft plastic material is embedded into the groove of the bottom lid. After the case is jointed to the bottom lid, glue is applied at a conjunction between the bottom lid and the case. Besides, the buttons made of the soft plastic material disposed is also manually embedded into a space formed at an outer rim of the case, and glue is applied at the conjunction. Furthermore, another conventional method of manufacturing plastic watch case includes no water-proof gasket, and only glue is applied at the conjunction between the case and the bottom lid after jointing the bottom lid to the case.

However, the process of embedding and applying glue manually could be affected due to the operation quality (for example, physical and psychological problems), and may lead to inaccuracy, low production yield and the manual process is more complex. Besides, drying of the glue takes time, so the process time is prolonged. Furthermore, when repairing the watch, the bottom lid has to be disassembled from the case for opening the case. In doing so, the water-proof effect of the watch will be adversely affected.

Therefore, how to overcome the defects of the conventional design is an important issue for the manufacturer in the field.

### SUMMARY OF THE INVENTION

According to an aspect of the present invention, a method for manufacturing a water-proof watch with GPS is provided, which includes injecting two different plastic materials, for example, a hard plastic material and a soft plastic material, into a mold to form a case, a bottom lid, a water-proof gasket and at least one button. Because the properties of the two different plastic materials, the case, the bottom lid, the water-proof gasket and the button have the water-proof effect. Thus, the method of the present invention can effectively eliminate the need for manually embedding the water-proof gasket and the button into a conjunction between the bottom lid and the case and an outer rim of the case. Accordingly, the time required to adhere the components, as in the case of the prior art, may be effectively saved, and the throughput can be effectively increased. Thus, when the case is opened for repairing the watch, the water-proof gasket will not get damaged.

### BRIEF DESCRIPTION OF THE DRAWING

FIG. 1 is a flow chart illustrating a process for manufacturing a water-proof watch case according to an embodiment of the present invention.

FIG. 2 is an exploded view of a water-proof watch case according to an embodiment of the present invention.

FIG. 3 is a perspective view of a bottom lid according to an embodiment of the present invention.

FIG. 4 is a view showing the jointing of the bottom lid to the case according to an embodiment of the present invention.

FIG. 5 is an enlarged sectional view of the FIG. 4.

FIG. 6 is a perspective view of a watch according to an embodiment of the present invention.

### DETAIL DESCRIPTION OF THE INVENTION

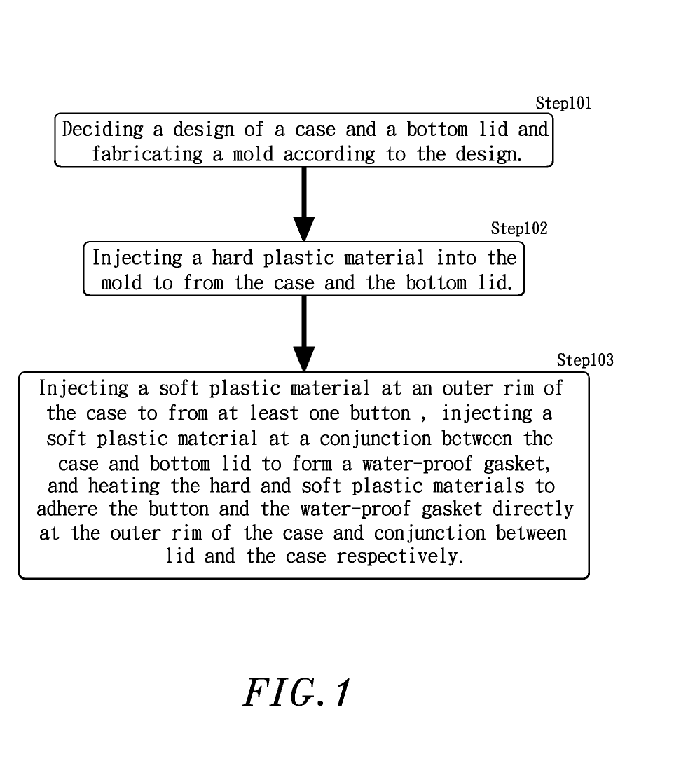

Referring to FIG. 1, the process of manufacturing a water-proof watch case of the present invention is described as follows:

(101) deciding a design of a case and a bottom lid and fabricating a mold to manufacture the case and the bottom lid;

(102) injecting a hard plastic material into the mold to form the case and the bottom lid;

(103) injecting a soft plastic material at an outer rim of the case to form at least one button, injecting a soft plastic material at a conjunction between the case and the bottom lid to form a water-proof gasket, and heating the hard and soft plastic materials to adhere the button and the water-proof gasket directly to the outer rim of the case and the conjunction between the bottom lid and the case respectively.

The method of the present invention described above is capable of manufacturing a variety of types of cases of the watch with water-proof capability. According to an embodiment of the present invention, the watch comprises GPS (global positioning system).

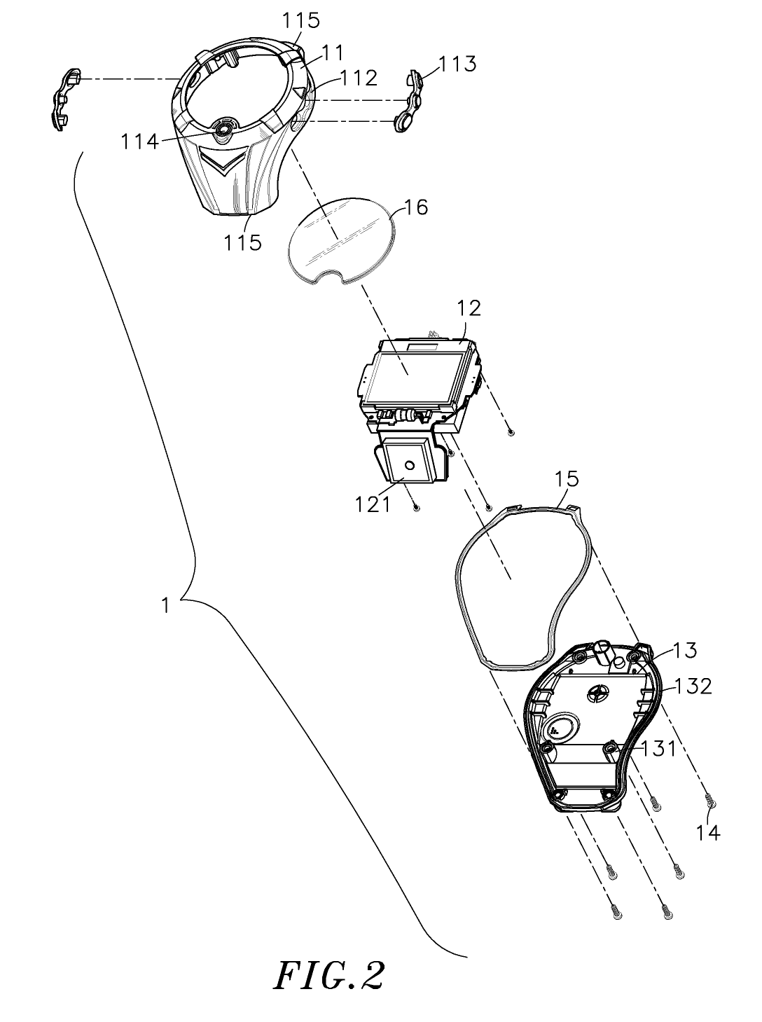

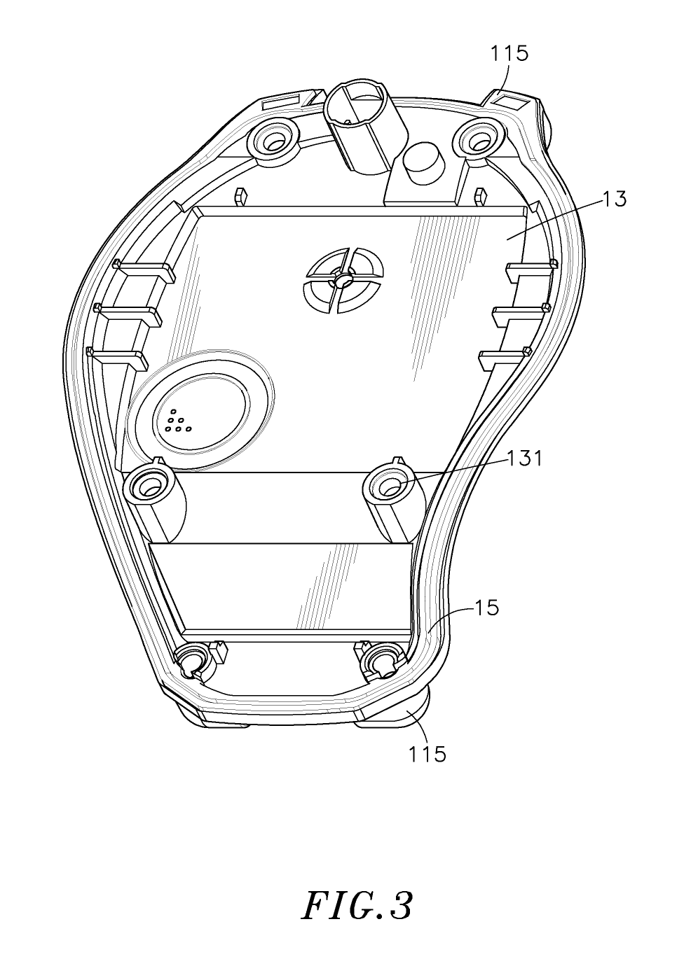

Referring to FIGS. 2 and 3, a watch 1 of the present invention is shown comprised of a case 11, movement components 12, a GPS module 121 and a bottom lid 13. The movement components 12 and the GPS module 121 are embedded and secured at a bottom of the case 11 by using first securing elements 131 (for instance, threaded portions) of the bottom lid 13 and second securing elements 14 (for instance, screws) to prevent water entering into the case 11 from a conjunction between the case 11 and the bottom lid 13. Thus, the service life of the movement components 12 and the GPS module 121 may be effectively prolonged. Further, a water-proof gasket 15 may be directly adhered at the conjunction between the bottom lid 13 and the case 11 to effectively seal the conjunction to provide effective water-proof effect.

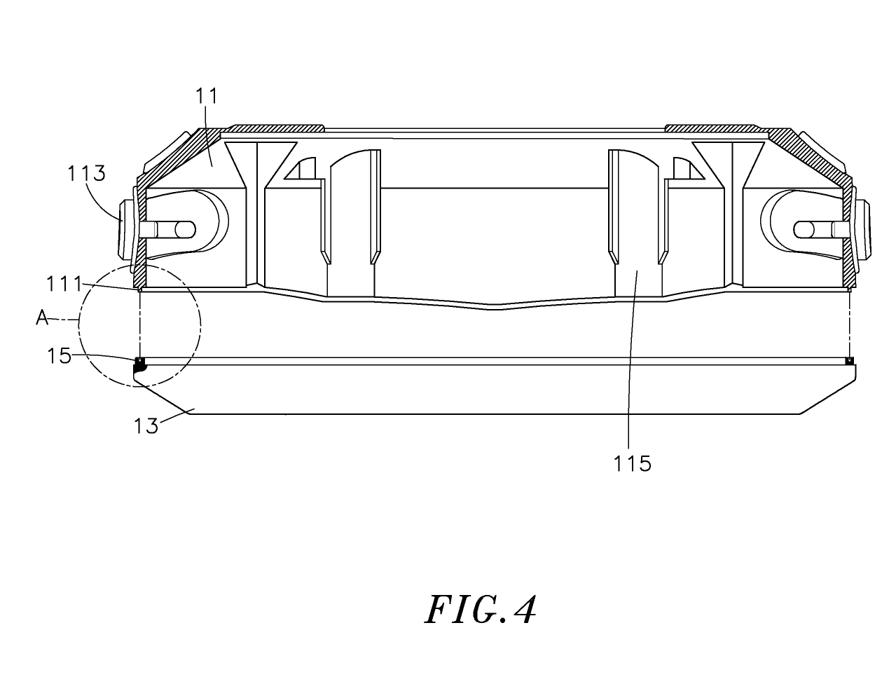

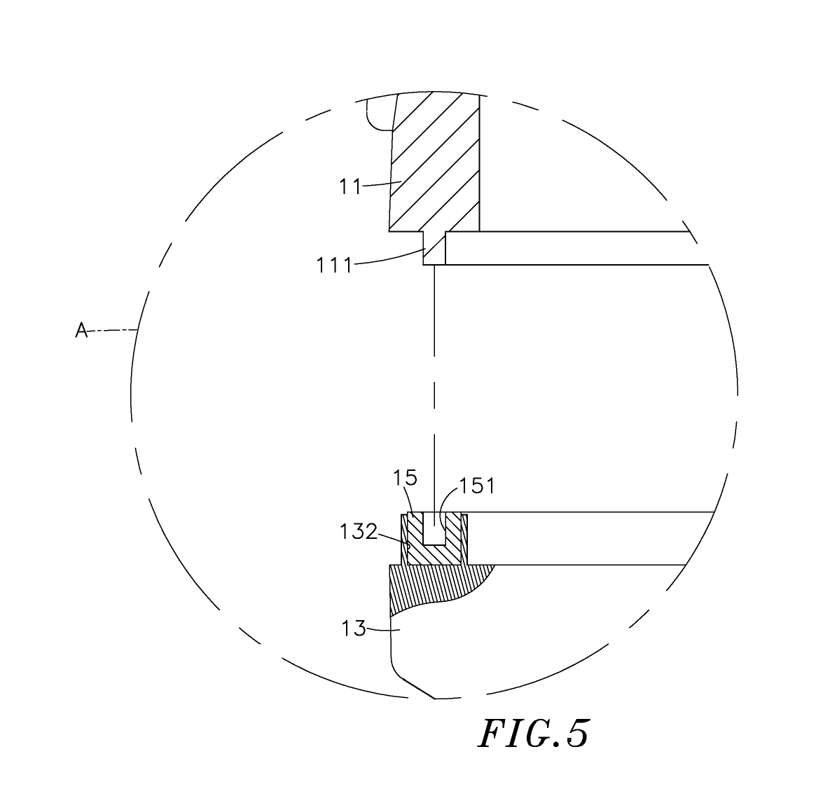

Referring to FIGS. 4, 5 and 6, the water-proof gasket 15 is directly adhered on a groove 132 of the bottom lid 13 (as shown in FIG. 5), and a rib 111 of the case 11 can be embedded into a groove 151 of the gasket 15 (as shown in FIG. 5). The rib 111 of the case 11, which is comprised of a hard plastic material, and the groove 151 of the gasket 15, which is comprised of a soft plastic material, can effectively seal the conjunction between the bottom lid 13 and the case 11 to achieve watch-proof effect.

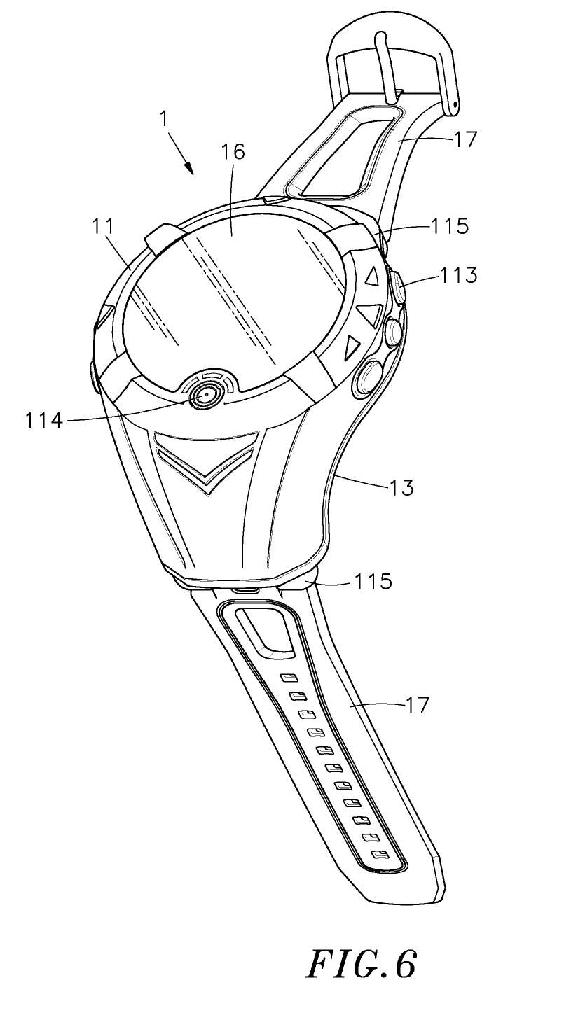

Besides, an outer rim of the case 11 has at least one space 112, which is comprised of a hard plastic material, for embedding at least one button 113, which is comprised of a soft plastic material, to achieve water-proof effect (as shown in FIG. 2). Furthermore, the case 11 has a lens 16 embedded therein. Finally, the bottom lip 13 is secured to the case 11 by screwing the second securing elements 14 (for instance, the screws) to the first securing elements 131 (for instance, the threaded portions). Thus, the assembly of the watch 1 with GPS of the present invention is completed (as shown in FIG. 6). A GPS portion 114 corresponding to the GPS module 121 is mounted on the case 11, and the case 11 has two connecting portions 115 extending from two sides thereof. The connecting portions 115 each are connected to a watchband 17 that may be used by a user to wear the watch on the wrist. However, the round shape of the case 11 of the watch 1 is simple examples of the present invention, not a limitation.

Accordingly, the water-proof watch with GPS and the method of manufacturing the same are more advantageous than the conventional art. For example, the water-proof gasket 15 and the buttons 113 don't need to be manually embedded and glued into the conjunction between the bottom lid 13 and the case 11 and the outer rim of the case 11, and therefore, not only the time is being saved but also low yield and defects due to manual operation may be effectively avoided. The present invention also uses the properties of the two different materials (the hard and soft plastic materials) to seal to effectively achieve water-proof effect and also uses the plastic injection molding process to increase the manufacturing efficiency. Furthermore, the use of the first securing elements 131 (for instance, the threading portions) and the second securing elements 14 (for instance, the screws) to secure the bottom lid 13 to the case 11 will not damage the water-proof gasket 15 when the case 11 is opened for repairing.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A method for manufacturing a water-proof watch case with GPS, comprising:
deciding a design of a case and a bottom lid, and fabricating a mold according to said design;
injecting a hard plastic material into said mold to form said case and said bottom lid; and
injecting a soft plastic material at an outer rim of said case to form at least one button, injecting a soft plastic material at a conjunction between said case and said bottom lid to form a water-proof gasket, and heating said hard and said soft plastic materials to adhere said button and said water-proof gasket to said outer rim of said case and said conjunction between said bottom lid and said case respectively.

2. The method for manufacturing a water-proof watch case with GPS accordingly to claim 1, wherein said case comprises a GPS portion.

3. The method for manufacturing a water-proof watch case with GPS accordingly to claim 1, wherein said conjunction between said case and said bottom lid comprises a rib at said case and a groove at said bottom lid.

4. A water-proof watch case with GPS, comprising
a case, comprising a least one space at an outer rim for mounting at least one button, and a GPS portion;
a movement component, embedded in said case;
a GPS module, embedded in said case, and corresponds to said GPS portion;
a bottom lid, securely assembled to a bottom of said case by using first securing elements and second securing elements, wherein a water-proof gasket is disposed at a conjunction between said bottom lid and said case.

5. The water-proof watch case with GPS according to claim 4, wherein said water-proof gasket is adhered to a groove on said bottom lid, and a rib of said case is embedded into a groove of said water-proof gasket.

6. The water-proof watch case with GPS according to claim 4, wherein said case comprises a lens.
